(19) United States
(12) Patent Application Publication
(10) Pub. No.: US 2026/0346537 A1
(43) Pub. Date: Nov. 5, 2026

(54) HELICAL WRAP CABLE INSTALLATION TOOL

(71) Applicant: TerraPower, LLC, Bellevue, WA (US)

(72) Inventor: James D. Jarrell, III, Everett, WA (US)

(21) Appl. No.: 19/558,348

(22) Filed: Mar. 5, 2026

Related U.S. Application Data
(60) Provisional application No. 63/800,411, filed on May 5, 2025.

(51) Int. Cl. B29C 63/10; B33Y 80/00; B65H 81/06

(52) U.S. Cl. CPC B29C 63/105; B65H 81/06; B33Y 80/00; H05B 2203/017

(57) ABSTRACT

A system and method for installing cable heaters, such as Mineral Insulated (MI) cable heaters, around pipes is disclosed. The system comprises a modular installation tool that streamlines the cable wrapping process and ensures consistent, accurate placement of the cable heater with a desired pitch. The tool consists of interlocking segments with helical channels corresponding to the desired wrapping pitch, allowing for customization to accommodate different pipe diameters and cable sizes. In use, the cable heater is fed through the helical channel of the assembled tool, which is positioned around the pipe and rotated, guiding the cable heater into place. Embodiments of the system and method minimize the risk of human error, improve heating performance and efficiency, and reduce the risk of cable damage. The modular, adaptable, and user-friendly nature of the installation tool enhances the efficiency, reliability, and safety of cable heater installations across various industries.

### GOVERNMENT LICENSE RIGHTS

This invention was made with government support under DOE Cooperative Agreement No. DE-NE0009045 awarded by the U.S. Department of Energy. The government has certain rights in the invention.

### FIELD OF THE DISCLOSURE

This disclosure is directed to a helical cable wrapping tool.

### BACKGROUND

In the field of cable installation, particularly for electrical resistance heating cables such as Mineral Insulated (MI) Cable Heaters, manual installation presents significant challenges. Existing methods typically involve manually wrapping the cable around a pipe, which is labor-intensive and can pose ergonomic risks to the installers. These issues are exacerbated when an operator attempts to achieve precise helical wrapping, as the process requires considerable physical effort and can result in hand strain or injury.

Additionally, the precision required for proper cable installation is difficult to achieve consistently when done manually. The inherent fragility of MI cables, comprising a thin power conduit insulated by a nonconductive powder within a thin-walled metal sheath, further complicates the process; improper handling or excessive bending during manual installation may damage the cable, rendering it useless and necessitating its replacement. This creates a concern for operational efficiency, as multiple attempts might be needed to attain the desired configuration, leading to increased time consumption and potential material waste.

While modular tools for assisting various cable installations may exist, they often lack the customization required for accommodating different pipe diameters, cable sizes, and wrap pitches specific to MI Cable Heater installations.

In light of these challenges, there is a clear need for an improved cable heater installation system that addresses the limitations of manual installation methods while providing a high degree of customization and adaptability.

The lack of a tailored solution that addresses ergonomic concerns, ensures accurate installation, and mitigates the risk of cable damage, highlights a technological gap in the current offerings for cable installation tools. These, and other benefits, will become readily apparent to those of skill in the art by reference to the following description and appended figures.

### SUMMARY

According to some embodiments, a cable wrapping tool for wrapping a cable around a pipe at a desired pitch, includes a plurality of links, each link having a first end and a second end, wherein the first end of each link is configured to couple to the second end of an adjacent link; a curved surface on each link (alternatively referred to as a curved face), wherein the curved surfaces of the plurality of links form a substantially circular shape when the links are coupled together; at least one helical groove formed on the curved surface of each link, wherein the at least one helical groove of each link aligns with the at least one helical groove of adjacent links when the links are coupled together to form a continuous helical path; and a coupling mechanism configured to couple the first end of each link to the second end of an adjacent link.

In some cases, the coupling mechanism comprises a tab extending from the first end of each link; a groove formed in the second end of each link, the groove configured to receive the tab of an adjacent link; and a pin configured to be inserted through a hole in the tab and a corresponding hole in the second end of the adjacent link to pivotally couple the links together.

In some instances, the curved surface of each link has a radius of curvature that is slightly larger than an outer diameter of the pipe. In this way, the links and the assembled tool can be custom made for a specific pipe diameter. Similarly, the at least one helical groove on each link comprises two helical grooves spaced apart from one another by a distance equal to the desired pitch of the cable wrap. Thus, the helical groove on each link may be customized for a specific cable diameter and a specific wrapping pitch.

In some cases, the plurality of links are formed through an additive manufacturing process.

In some embodiments, a handle is coupled to at least one of the plurality of links, the handle extending radially outward from the substantially circular shape formed by the coupled links. A strap clamp may be used with the tool to compress the links together and provide a gripping surface for rotating the tool around the pipe.

According to some embodiments, a method for wrapping a cable around a pipe at a desired pitch includes the steps of providing a plurality of links, each link having a curved surface with at least one helical groove formed thereon; coupling the plurality of links together such that the curved surfaces of the links form a substantially circular shape and the at least one helical groove of each link aligns with the at least one helical groove of adjacent links to form a continuous helical path; positioning the coupled links around the pipe; feeding the cable into the continuous helical path formed by the aligned helical grooves; and rotating the coupled links around the pipe, thereby guiding the cable to wrap around the pipe at the desired pitch.

The method may include inserting a tab extending from a first end of each link into a groove formed in a second end of an adjacent link; and inserting a pin through a hole in the tab and a corresponding hole in the second end of the adjacent link to pivotally couple the links together.

In some cases, the curved surface of each link has a radius of curvature that is slightly larger than an outer diameter of the pipe.

The at least one helical groove on each link may include two helical grooves spaced apart from one another by a distance equal to the desired pitch of the cable wrap.

The plurality of links may be formed through an additive manufacturing process, such as 3D printing.

The method may include the step of attaching a handle to at least one of the plurality of links, the handle extending radially outward from the substantially circular shape formed by the coupled links. In some cases, the handle is integrally formed with at least one of the links, or may be a separate component that is attached to the tool.

A strap clamp may be used to compress the links together and provide a gripping surface for rotating the tool around the pipe.

Optionally, the method may include loosely wrapping the cable around the pipe before positioning the coupled links around the pipe.

### BRIEF DESCRIPTION OF THE DRAWINGS

FIG. 1 illustrates a link that can be coupled to another link to form a tool, in accordance with some embodiments;

FIG. 2 illustrates plurality of links coupled together, in accordance with some embodiments;

FIG. 3 illustrates a plurality of links coupled together forming an inner diameter configured to couple to a pipe, in accordance with some embodiments;

FIG. 4 illustrates plurality of links coupled to form a tool being applied to a pipe, in accordance with some embodiments;

FIG. 5 illustrates a tool coupled to a pipe and used to wrap a cable around the pipe at a desired pitch, in accordance with some embodiments; and

FIG. 6 illustrates a process flow for assembling a plurality of links to form a cable wrapping tool and using the tool to wrap a cable around a pipe at a desired pitch, in accordance with some embodiments.

FIG. 7 illustrates a link having reinforcements at locations along the faces of the link, in accordance with some embodiments.

### DETAILED DESCRIPTION

This disclosure generally relates to methods and systems for providing a helical cable wrapping tool that is configured to wrap a cable around a pipe at a desired pitch. Cable heaters, such as, for example, Mineral Insulated (MI) cable heaters, are commonly installed around piping systems to ensure uniform heating along the pipe surface. This installation method is useful for applications that require precise temperature maintenance or freeze protection. In some cases, MI cables are constructed with a central conductor, typically made of nickel or copper, which functions as the heating element. This conductor is encased within a casing of non-conductive material that provides both electrical insulation and thermal conduction. Such suitable non-conductive materials may be mineral powders that are applied to the conductor, such as, for example, magnesium oxide, aluminum oxide, silicon dioxide, calcium oxide, boron nitride, beryllium oxide, and others depending on factors such as the desired thermal conductivity, dielectric strength, operating temperature range, and compatibility with sheath materials. In some cases, the mineral powder may be compacted around the conductor to form a dense, non-conductive layer that provides both electrical insulation and thermal conduction.

The entire assembly may be further protected by a thin-walled metal sheath, usually made of stainless steel or another durable metal, which shields the cable from environmental factors and mechanical damage.

According to some embodiments, the installation process involves wrapping the cable helically around the pipe in evenly spaced turns, (e.g., at a desired pitch) which promotes consistent heat distribution along the length of the pipe. In some cases, additional materials, such as thermal insulation, may be applied to the pipe following cable installation. The process may begin with a few initial turns of the cable being manually wrapped around the pipe to establish the desired helical pattern. Specialized tools, like a helical wrap cable installation tool, can be employed to maintain precision in the spacing and pitch of the cable wraps. Once the cable is fully wrapped, it is secured in place, such as by using clips, ties, or other suitable fasteners to prevent movement and ensure proper thermal contact.

The helical wrap configuration offers several functional benefits. Firstly, it ensures uniform heating by evenly distributing heat along the surface of the pipe, minimizing the risk of thermal gradients that could lead to uneven heating or localized hot spots. This uniform temperature maintenance enhances operational efficiency by inhibiting viscosity changes in transported materials and reducing the likelihood of blockages caused by freezing or solidification.

The helical wrap is preferred over other configurations due to its ability to optimize contact between the cable and the pipe, thereby enhancing heat transfer efficiency and reducing temperature gradients. Additionally, this method accommodates the expansion and contraction of the pipe during operations, as the flexible nature of the MI cable can compensate for minor dimensional changes without compromising the installation integrity.

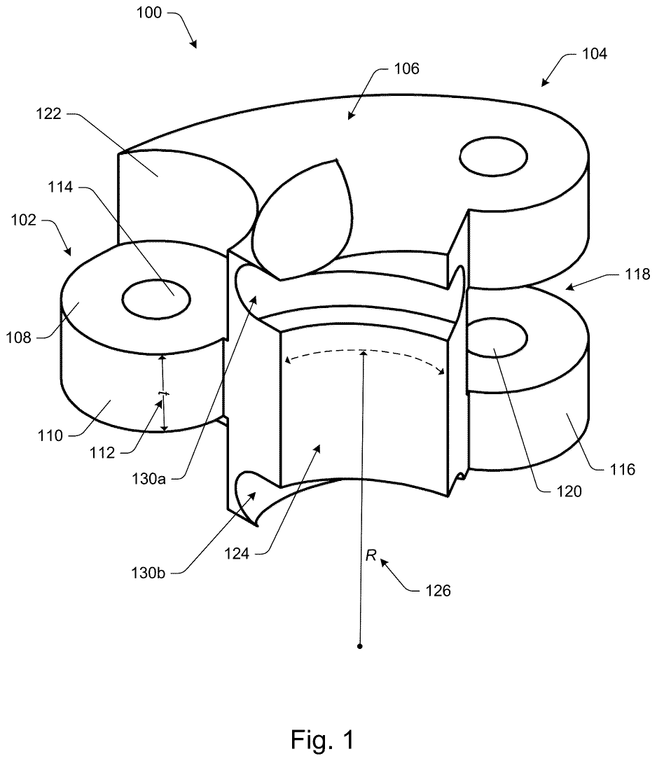

FIG. 1 illustrates a link 100 that can be combined with additional links to form a helical cable wrapping tool, in accordance with some embodiments.

The link 100 has a first end 102 and a second end 104 and a body portion 106 therebetween. The first end 102 includes a tab 108 that extends outward from a first end of the body portion 106. The tab 108 may include an arcuate face 110 and a thickness t 112. The tab 108 has a through hole 114 formed transversely therethrough. The second end 104 of the body portion 106 includes a second arcuate face 116 and a groove 118 formed through the second arcuate face 116 to effectively bifurcate the second arcuate face 116 into two sides of the groove 118. The groove 118 may be sized to receive the tab 108 from an adjacent link 100. The second end 104 of the body portion 106 may have a transverse hole 120 formed therethrough that may be configured to cooperate with the through hole 114 formed in the first end 102 of an adjacent link.

For example, the tab 108 of a first link 100 may be inserted into the groove 118 of a second link 100 such that their respective holes line up. A pin, fastener, bolt, screw, or other such device may pass through the cooperating holes to couple the first link to the second link. In some cases, the body portion 106 may include one or more recesses 122 to facilitate the coupling of the first link and the second link at the tab 108 and groove 118.

In some cases, the individual links 100 are configured to be coupled together to form a closed structure. In other words, a number of links may be coupled together such that each groove fits into a slot of an adjacent link and each link is coupled to an adjacent link to form a geometric shape. For example, in some cases, as the plurality of links are coupled together, the links form, or at least resemble, a circle. In some cases, a curved face 124 of the link 100 is provided such that when a certain number of links are coupled together, the respective curved faces 124 of the links form a circle. The curved face 124 is formed with a radius of curvature 126 (“radius”) such that when a certain number of links are joined together, the curved faces 124 of the coupled links form a circle. In some cases, the radius 126 is selected based upon the outer diameter (OD) of a pipe that is to be wound with a helical winding of a cable. For example, where the OD of a pipe to be wrapped is 1.5 inches (38 mm), the radius 126 may be about 0.75 inches (19 mm), or slightly larger to allow a tolerance between the curved faces 124 of the tool and the pipe. The tolerance of the radius may be selected based on the pipe to be wrapped, for instance, where the pipe is rough, then a larger tolerance may be selected. In many cases, the radius 126 of the curved surface 124 may be about 2%, or 5%, or 7%, or 10% larger than the pipe to be wrapped. In some cases, the tolerance may be a fixed distance, such as 0.001 inches, or 0.002 inches, or 0.005 inches, or 0.010 inches. In some cases, providing a tolerance will allow the tool to more easily rotate about the pipe when applying the helical wrappings of the cable.

The curved surface 124 of the body portion 106 may additionally be formed to have one, two, or more helical grooves 130a, 130b. The helical grooves 130a, 130b may be formed with a radius that is based, at least in part, on the cable to be wrapped around the pipe. For example, where the cable to be wrapped has a diameter of ¼ inch (6 mm), the radius of the helical grooves 130a, 130b may be ⅛ inch (3 mm) or larger. It has been found that providing a helical groove that is larger than the cable to be wrapped helps to protect the fragile cable during the wrapping process. Therefore, in some cases, the helical groove may have a diameter that is 5%, 10%, 15%, 20%, 25%, 30%, 40%, or 50% larger or more than the cable diameter.

In some examples, each link 100 includes 2 helical grooves that are spaced apart from one another on the curved surface 124 a distance equal to the desired pitch of the helically wrapped cable. In some applications, the cable should be wrapped at a certain pitch in order to provide sufficient heating to avoid detrimental effects with incomplete heating.

For example, when wrapping a cable heater, such as a Mineral Insulated (MI) Cable Heater, around a pipe, the pitch of the cable wrap plays an important role in ensuring efficient and uniform heat distribution along the length of the pipe. The pitch, which refers to the distance between two consecutive wraps of the cable, usually expressed in wraps per inch (WPI) directly influences the heating performance and overall effectiveness of the system.

Maintaining a specific pitch when wrapping a cable heater provides more consistent and evenly distributed heat transfer from the cable to the pipe surface. By carefully controlling the spacing between each wrap, the system can ensure that the pipe is heated uniformly, minimizing the occurrence of hot spots or cold zones. This may become especially important in applications where precise temperature control is critical, such as in process industries where the fluid within the pipe must be maintained at a specific temperature to prevent solidification, condensation, or other undesirable changes in physical properties.

Moreover, the pitch of the cable wrap also affects the power density of the heating system. Power density refers to the amount of heat generated per unit length of the cable, and it is determined by the cable's resistance and the applied voltage. By selecting an appropriate pitch, the system designer can optimize the power density to match the specific heating requirements of the application. A smaller pitch, resulting in more wraps per unit length, will increase the power density and provide more intense heating, while a larger pitch will reduce the power density and deliver gentler, more distributed heating.

In addition to its impact on heating performance, the pitch of the cable wrap also influences the mechanical stability and longevity of the system. When the cable is wrapped too tightly, with a small pitch, it may be subjected to increased mechanical stress and strain, particularly during thermal expansion and contraction cycles. This can lead to accelerated wear and tear, potentially causing damage to the cable's insulation or conductor over time. On the other hand, if the pitch is too large, the cable may be prone to sagging or shifting, which can result in uneven contact with the pipe surface and reduced heat transfer efficiency.

Furthermore, the pitch of the cable wrap can impact the overall installation process and maintainability of the system. A well-designed pitch allows for easier installation, as it provides sufficient flexibility for the cable to conform to the contours of the pipe while maintaining proper spacing. This is particularly relevant when installing cable heaters on complex pipe geometries or in tight spaces. Additionally, a suitable pitch facilitates easier access for maintenance, repairs, or replacements, as it allows for individual cable sections to be removed or replaced without disturbing the entire installation.

To determine the optimal pitch for a specific application, several factors must be considered, including the pipe diameter, the cable diameter, the desired power density, and the operating temperature range. Calculations based on these parameters, along with empirical data and industry standards, help system designers select the most appropriate pitch for each installation.

These calculations provide input into the design of the links, which include the pipe diameter, the cable diameter, and the desired pitch, which directly influences the geometry of the links 100 to ensure that when the links are coupled, their respective curved surfaces 124 approximate the OD of the pipe, the helical grooves 130a, 130b, accommodate the cable and provide the proper pitch spacing. In some embodiments, a tool is formed for a specific pipe, wire, and pitch combination.

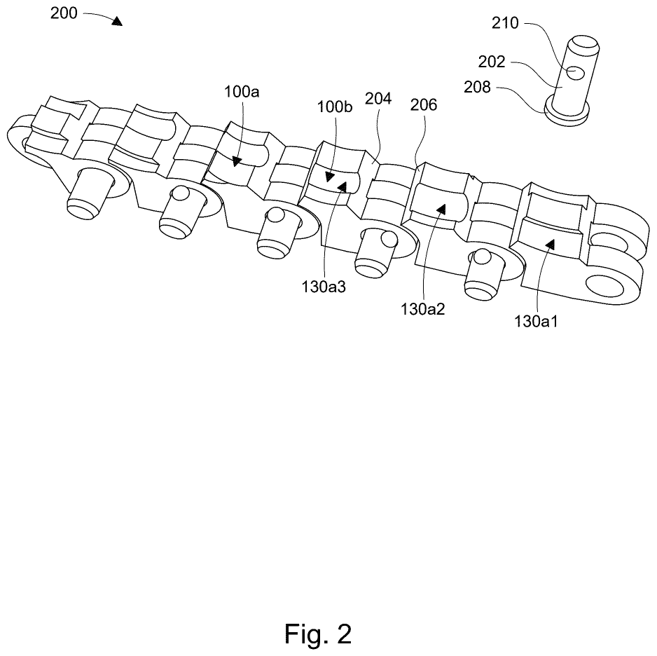

FIG. 2 illustrates a plurality of links 100 coupled together to form a linked assembly 200 with a pin 202, according to some embodiments. As shown, a first link 100a is coupled to a second link 100b by inserting the tab of the second link 100b into the groove of the first link 100a and securing them together with a pin 202. This provides a pinned connection that allows the first link 100a and the second link 100b to pivot relative to one another. In some cases, each of the links 100a, 100b has a first interfering face 204 and a second interfering face 206. In use, the first interfering face 204 and second interfering face 206 of an adjacent link 100 are configured to provide an interference with one another to define the maximum pivoting of one link relative to an adjacent link. In other words, as the adjacent links 100a, 100b are pivoted about the pin 202, the respective interference faces 204, 206 contact one another to limit the amount of relative pivotal movement. The interference faces 204, 206 additionally align the respective helical grooves of adjacent links to cooperate to form a helical path through the tool.

As used herein, the word “tool” is a broad term and is used to mean a plurality of links that are coupled together. In some embodiments, the tool comprises 6 links, or 8 links, or 4 links, or 10 links, or some other number of links that are configured to helically wrap a cable of a specific diameter around a pipe having a specific diameter at a desired pitch.

In some embodiments, the pin 202 may have a first end having a head 208 that is sized to be larger than the holes formed in the links to inhibit the head 208 of the pin from passing through the transverse holes in the links 100a, 100b. The pin 202 has a second end near which a retainer 210 is formed. The retainer 210 may be used, for example, once the pin 202 is inserted through the transverse holes to couple a first link 100a and a second link 100b. The retainer 210 inhibits removal of the pin 202 from the transverse holes of the links. The retainer may be any suitable device that inhibits removal of the pin. In some cases, the retainer is a ball that may be spring loaded to allow the ball to be compressed into the pin upon insertion of the pin into the links, and the ball may further be compressed into the pin to selectively remove the pin from the links. The retainer 210 may include a hole formed through the pin 202 and a cotter pin that fits through the hole in the pin 202 to inhibit removal of the pin. Of course, these are provided as examples of suitable retainers, and any suitable retainer may be used to inhibit the pin 202 from being removed from the links.

Each link 100 includes two helical grooves 130a, 130b spaced apart from one another, as described above with reference to FIG. 1. When the links are coupled together to form the tool, the helical grooves 130a, 130b of each link align with the corresponding helical grooves of adjacent links to form continuous helical paths along the inner diameter of the tool. As shown in FIG. 2, the reference characters 130a1, 130a2, 130a3 identify the first helical groove 130a on sequential links, illustrating how the groove segments align to form the continuous helical path. This is also shown in reference to the following figure.

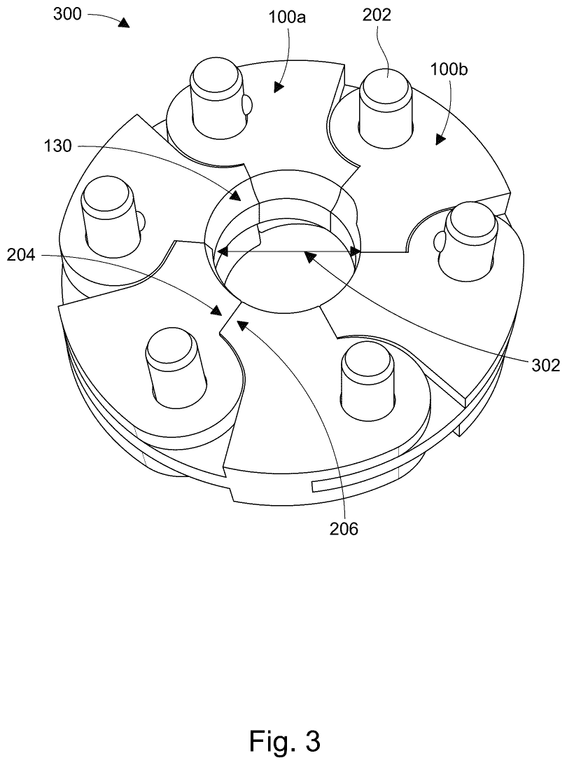

FIG. 3 illustrates a plurality of links coupled together to form a tool 300 having an inner diameter configured to couple to a pipe, in accordance with some embodiments. As shown a first link 100a is coupled to a second link 100b by a pin 202. Additional links are coupled to the first and second link to form a closed shape. As shown, the plurality of links, when coupled together to form the tool, form a closed shape and the inner portion of the tool is a circle having a diameter 302 that is determined by the curved faces of the cooperating links. As discussed above, the diameter 302 may be configured to be slightly larger than the OD of the pipe to be wrapped.

A helical groove 130 is formed about the inner diameter of the tool 300 and, as illustrated, the helical groove 130 make greater than a full revolution about the inner diameter of the tool 300. In some cases, the helical groove 130 is formed to make two full revolutions, or three full revolutions or more about the inner diameter of the tool 300. In order to accomplish the revolutions of the helical groove 130, each link in the tool 300 is formed to cooperate with adjacent links, and in some instances, no two links are identical because of the helical groove 130. The pitch of the helical groove 130 serves to define the pitch of the cable that the tool 300 wraps about the pipe as the helical groove 130 guides the cable as the tool 300 is rotated about the pipe.

As is shown in FIG. 3, the interference faces 204, 206 are in surface contact with one another when the tool is closed. In some cases, the interference faces 204, 206 provide a limit to the angle at which one link can pivot relative to an adjacent link, and in some cases, may also help to define the inner diameter 302 of the tool.

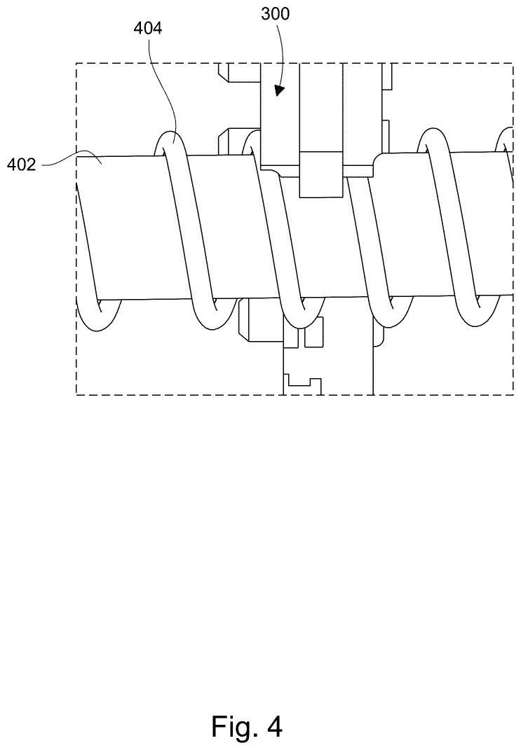

FIG. 4 illustrates plurality of links coupled to form a tool 300 being applied to a pipe 402, in accordance with some embodiments. In the illustrated embodiment, the tool 300 has not yet been fully assembled or coupled to the pipe 402. In some cases in which the tool 300 has 6 links, the links may be coupled by 5 pins, and the plurality of links may be wrapped around the tool and then a final pin is connected thus closing the tool about the pipe and coupling the tool to the pipe. A cable 404 may be initially loosely wrapped about the pipe 402 and as the tool is rotated about the pipe 402, the tool captures the cable 404 and causes the cable to ride inside the helical groove within the tool and become wrapped about the pipe at the pitch dictated by the helical groove.

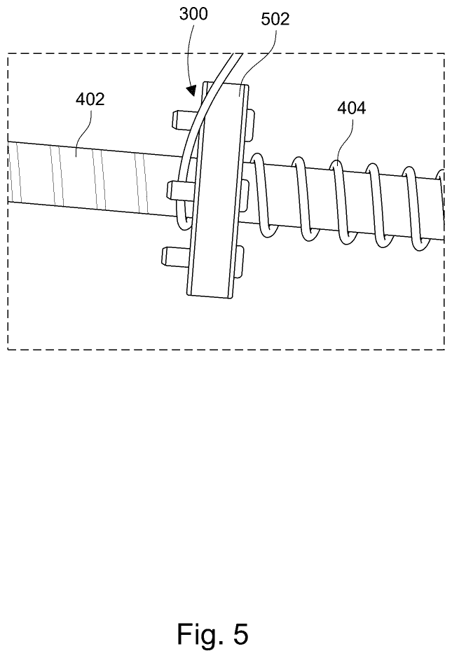

FIG. 5 illustrates a tool 300 coupled to a pipe 402 and used to wrap a cable 404 around the pipe 402 at a desired pitch, in accordance with some embodiments. As shown, each of the links is coupled to adjacent links, which causes the tool 300 to be coupled to the pipe and it cannot be removed from the pipe unless it slides off the end of the pipe, or two of the links are uncoupled, such as by removing the pin that couples the links together. In some cases, the links may be compressed or clenched together, such as by another apparatus. In the illustrated embodiments, the tool 300 is compressed by a strap clamp 502 which may be applied to the tool not only to compress the links of the tool together, but also provide a handle for revolving the tool 300 about the longitudinal axis of the pipe 402.

In some embodiments, one or more of the links may be formed with a handle that protrudes away from the tool in a radial direction away from the pipe, thus providing a user with a handle that aids in revolving the tool about the longitudinal axis of the pipe. In some embodiments, a handle may be formed integrally with one or more of the links and may further define a hollow central pathway through the handle to an interior portion of the tool. For example, a hollow handle provides a pathway for the cable to be inserted through the handle and into the helical channel formed inside the tool. In addition, the collection of cable may be held by the handle such that the collection of cable revolves around the pipe with the tool and the inventory of cable remains held by the handle as a working end of the cable is drawn into the handle and into the helical grooves as the tool revolves around the pipe. As can be seen in the illustration, the tool has been revolved about the pipe a number of times and the cable 404 has been wrapped about the tool at a desired pitch.

While specific embodiments of links and couplings have been shown and described herein, it should be apparent to those of skill in the art that a number of variations may be introduced to provide the same functionality with slightly different components. For instance, rather than tabs, grooves, and pins holding the links together, the links may be held together by clips, clasps, hooks, fasteners, or some other structure. In addition. While many of the embodiments show a plurality of links being coupled together to form the tool, the tool may be formed by 2 links that clamshell together to couple to the pipe. Similarly, the tool may have a single link. For example, a tool that is compliant may not be fully closed, but the compliance of the tool allows it to be separated sufficiently to be applied to a pipe. In some cases, a tool may have 2 links that are pivotally coupled together. In use, as the two links are applied around the pipe and brought in proximity to one another, a clasp, hasp, pin, or other structure may couple the links together to complete the application of the tool to the pipe.

In some other embodiments, as the tool is applied to a pipe, two of the links may have portions of a handle formed therein. For instance, as the tool is coupled to a pipe, a first portion of a handle from a first link is brought into proximity, or into contact, with a second portion of a handle from a second link, and the two handle portions may be coupled together by a structure, or a user may grasp the handle portions to maintain the tool applied to the pipe.

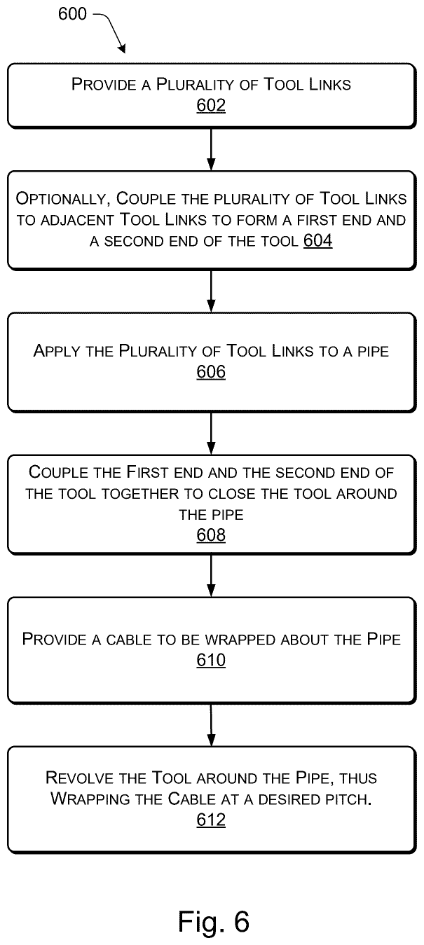

FIG. 6 illustrates a process flow 600 for assembling a plurality of links to form a cable wrapping tool and using the tool to wrap a cable around a pipe at a desired pitch, in accordance with some embodiments.

At block 602, a plurality of tool links are provided. As described, there may be one, two, six, eight, or more tool links and the number may be selected based upon the diameters of the pipe and the cable, among other things. The links may be formed through any suitable manufacturing process. For example, the links may be formed through an additive manufacturing process, such as 3D printing. The links may be formed through a suitable material removal process, such as machining. The links may likewise be formed through any suitable molding process. In some cases, the links may be formed through a combination of manufacturing processes.

Embodiments described herein may be formed from any of a number of suitable materials. For example, various types of polymers, such as ABS (Acrylonitrile Butadiene Styrene), Nylon, PLA (Polylactic Acid), or PETG (polyethylene terephthalate glycol) could be used to manufacture the links and other components of the tool. These materials offer good strength-to-weight ratios, durability, and resistance to environmental factors such as moisture and chemicals. They also provide excellent moldability and can be easily colored or textured to enhance visibility and grip. Reinforced plastics may be used to provide improved strength and stiffness of the tool. Reinforced plastics may include carbon fiber or glass fiber reinforced polymers. These materials offer superior mechanical properties compared to unreinforced plastics, making them suitable for demanding applications or larger-scale tools.

In some cases, especially in applications requiring high strength, stiffness, or temperature resistance, metal alloys such as aluminum, steel, or titanium could be used. These materials provide excellent mechanical properties and durability.

Finally, composite materials, such as fiber-reinforced plastics or metal-matrix composites, could be used to achieve a balance of strength, stiffness, and weight. These materials can be tailored to specific application requirements by selecting the appropriate matrix and reinforcement materials.

Some of the suitable manufacturing processes may involve injection molding, 3D printing, CNC machining, casting, and extrusion, to name a few. Injection molding is a common manufacturing method for producing plastic parts with high precision and consistency. This method involves injecting molten plastic into a mold cavity, which then cools and solidifies into the desired shape. Injection molding is suitable for high-volume production and can accommodate complex geometries, making it a good choice for manufacturing the links and other components of the cable wrapping tool.

Additive manufacturing techniques, such as Fused Deposition Modeling (FDM) or Selective Laser Sintering (SLS), could be used to produce the tool components. These methods build up the parts layer by layer from a digital model, allowing for rapid prototyping and customization.

Computer Numerical Control (CNC) machining could be used to manufacture the tool components from metal or plastic stock. This method involves the use of computer-controlled cutting tools to remove material and shape the parts to the desired geometry. CNC machining offers high precision and can accommodate a wide range of materials, making it suitable for producing high-quality, durable components.

Casting methods, such as sand casting or investment casting, could be used to produce metal components of the tool. These methods involve pouring molten metal into a mold cavity, which then cools and solidifies into the desired shape. Casting is suitable for producing complex geometries and can accommodate a wide range of metal alloys.

Extrusion could be used to produce continuous lengths of the tool components, such as the links or handle. This method involves forcing molten plastic or metal through a die of the desired cross-section, creating a long, uniform profile. Extrusion is suitable for producing high volumes of parts with consistent cross-sections.

Of course, a combination of methods could be used to form the links and the tool.

At block 604, the plurality of tool links are optionally coupled to adjacent tool links, save for the first and last tool links, which may not yet be coupled together. This provides a tool that is not yet closed so that it can be wrapped about the pipe before completing the assembly of the tool. The adjacent links may be coupled together through any suitable technique, and in some cases, the plurality of links may be permanently coupled together, such as during manufacturing. For example, in some embodiments, in an example using six tool links, the tool links may be permanently coupled together at five locations, leaving the first and last link uncoupled from each other. The permanent couplings may include integral connectors, bolts, pins, hinges, ball joints, clevis, bearings, or any suitable coupling structure.

At block 606, the tool links are applied to a pipe. This step may be performed by laying the tool across the pipe so that the first end and the second end of the tool are free to hang down adjacent the pipe.

At block 608, the first link and the last link are coupled together, thus closing the tool about the pipe.

At block 610, a cable to be wrapped about the pipe is provided. In some cases, the cable may be loosely wrapped about the pipe. In other cases, the cable, or a spool of cable, may be carried by the tool. In these cases, as the tool is revolved about the pipe, the spool of cable also wraps about the pipe before the leading edge of the tool captures the cable and causes the cable to enter the helical groove within the tool.

At block 612, the tool is revolved about the pipe, thus wrapping the cable about the tool at the desired pitch. As discussed, the desired pitch is controlled by the helical groove in the tool and as the tool is revolved about the pipe, the cable follows the helical groove, which lays the cable onto the pipe at the desired pitch.

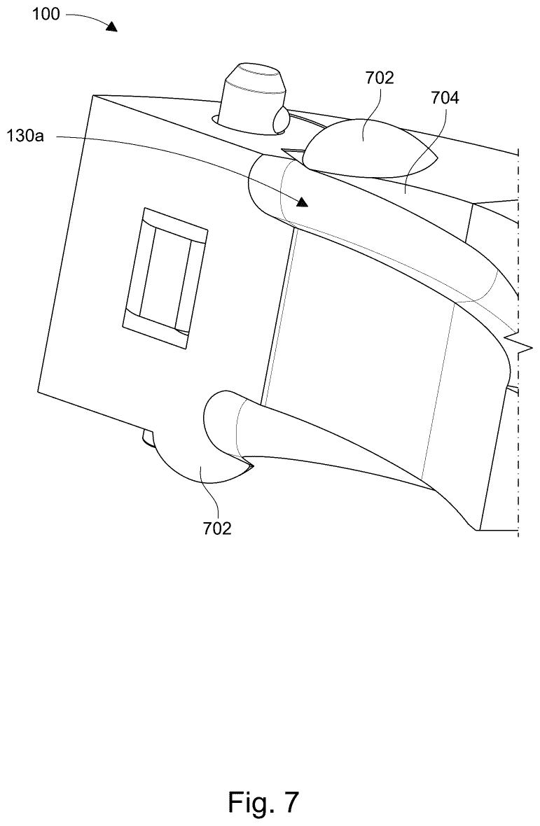

FIG. 7 illustrates a link 100 that has reinforcements 702 at locations along the faces of the link 100 to provide additional support for the walls of the helical groove 130a. In some cases, the helical groove, especially where it terminates near or at a sidewall 704 of the link 100 leaves a thin strip of material that may be weak. In these cases, one or more reinforcements 702 may be added to provide additional material to reinforce potential weak points in the links.

While some embodiments described herein relate to a specific embodiment of the cable wrapping tool, it should be understood that various modifications, variations, and alternative embodiments are possible without departing from the scope of the invention. The following discussion explores some of these potential variations and alternative embodiments.

Link shape and geometry: The disclosed embodiment utilizes links with a specific curved surface and tab/groove coupling mechanism. However, the shape and geometry of the links could be varied to suit different applications or manufacturing constraints. For example, the links could have a more angular or polygonal shape, or the coupling mechanism could be modified to use alternative fastening methods, such as snap-fits, magnets, or adhesives.

Number and arrangement of helical grooves: Some of the disclosed embodiments feature one or two helical grooves on each link. However, the number and arrangement of helical grooves could be varied to accommodate different cable wrapping patterns or multiple cables. For instance, the links could have three or more helical grooves, which may provide further registration with the cable.

Modular link design: The links could be designed with a modular approach, allowing for the addition or removal of sections to accommodate different pipe lengths or to facilitate repairs. This could involve a snap-together or bolt-together design, where individual link sections could be easily replaced or reconfigured as needed.

Motorized or automated rotation: While the disclosed embodiment relies on manual rotation of the tool around the pipe, the tool could be adapted for motorized or automated rotation. This could involve the integration of a motor, gearbox, and control system to drive the rotation of the tool, potentially increasing the speed and consistency of the cable wrapping process.

Adjustable pitch mechanism: The tool could incorporate an adjustable pitch mechanism, allowing for on-the-fly changes to the cable wrapping pitch without the need to swap out links or components. This could be achieved through the use of variable-geometry links, where the spacing between the helical grooves could be adjusted using a mechanical system. As an example, the links may be split along a line in between the two helical grooves such that the spacing between the two helical grooves of a link (e.g., the pitch) is adjustable.

Integrated cable tensioning and feeding: The tool could be designed with integrated cable tensioning and feeding mechanisms to further streamline the cable wrapping process. This could include a tensioning device to maintain consistent cable tension during wrapping and a feeding mechanism to automatically supply the cable to the tool at the appropriate rate.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A cable wrapping tool for wrapping a cable around a pipe at a desired pitch, comprising:
a plurality of links, each link having a first end and a second end, wherein the first end of each link is configured to couple to the second end of an adjacent link;
a curved surface on each link, wherein the curved surfaces of the plurality of links form a substantially circular shape when the links are coupled together;
at least one helical groove formed on the curved surface of each link, wherein the at least one helical groove of each link aligns with the at least one helical groove of adjacent links when the links are coupled together to form a continuous helical path; and
a coupling mechanism configured to couple the first end of each link to the second end of an adjacent link.

2. The cable wrapping tool of claim 1, wherein the coupling mechanism comprises:
a tab extending from the first end of each link;
a groove formed in the second end of each link, the groove configured to receive the tab of an adjacent link; and
a pin configured to be inserted through a hole in the tab and a corresponding hole in the second end of the adjacent link to pivotally couple the links together.

3. The cable wrapping tool of claim 1, wherein the curved surface of each link has a radius of curvature that is slightly larger than an outer diameter of the pipe.

4. The cable wrapping tool of claim 1, wherein the at least one helical groove on each link comprises two helical grooves spaced apart from one another by a distance equal to the desired pitch of the cable wrap.

5. The cable wrapping tool of claim 1, wherein the plurality of links are formed through an additive manufacturing process.

6. The cable wrapping tool of claim 1, further comprising a handle coupled to at least one of the plurality of links, the handle extending radially outward from the substantially circular shape formed by the coupled links.

7. The cable wrapping tool of claim 1, further comprising a strap clamp configured to compress the links together and provide a gripping surface for rotating the tool around the pipe.

8. A method for wrapping a cable around a pipe at a desired pitch, comprising:
providing a plurality of links, each link having a curved surface with at least one helical groove formed thereon;
coupling the plurality of links together such that the curved surfaces of the links form a substantially circular shape and the at least one helical groove of each link aligns with the at least one helical groove of adjacent links to form a continuous helical path;
positioning the coupled links around the pipe;
feeding the cable into the continuous helical path formed by the aligned helical grooves; and
rotating the coupled links around the pipe, thereby guiding the cable to wrap around the pipe at the desired pitch.

9. The method of claim 8, wherein coupling the plurality of links together comprises:
inserting a tab extending from a first end of each link into a groove formed in a second end of an adjacent link; and
inserting a pin through a hole in the tab and a corresponding hole in the second end of the adjacent link to pivotally couple the links together.

10. The method of claim 8, wherein the curved surface of each link has a radius of curvature that is slightly larger than an outer diameter of the pipe.

11. The method of claim 8, wherein the at least one helical groove on each link comprises two helical grooves spaced apart from one another by a distance equal to the desired pitch of the cable wrap.

12. The method of claim 8, wherein the plurality of links are formed through an additive manufacturing process.

13. The method of claim 8, further comprising attaching a handle to at least one of the plurality of links, the handle extending radially outward from the substantially circular shape formed by the coupled links.

14. The method of claim 8, further comprising applying a strap clamp to compress the links together and provide a gripping surface for rotating the coupled links around the pipe.

15. The method of claim 8, further comprising loosely wrapping the cable around the pipe before positioning the coupled links around the pipe.
